(19) United States
(12) Patent Application Publication
(10) Pub. No.: US 2017/0161704 A1
(43) Pub. Date: Jun. 8, 2017

(54) RETAIL TRANSACTION SYSTEM

(71) Applicant: Number 8 Technology Limited, Guildford Surrey (GB)

(72) Inventor: David Rimer, Guildford Surrey (GB)

(73) Assignee: Number 8 Technology Limited, Guildford Surrey (GB)

(21) Appl. No.: 15/321,428

(22) PCT Filed: Jun. 29, 2015
(86) PCT No.: PCT/EP2015/064698

§ 371 Date: Dec. 22, 2016

(30) Foreign Application Priority Data
Jul. 1, 2014 (GB) 1411660.2
Oct. 29, 2014 (GB) 1419250.4
Dec. 8, 2014 (GB) 1421790.5

(51) Int. Cl. G06Q 20/20; G06Q 20/34

(52) U.S. Cl. CPC G06Q 20/20; G06Q 20/34

(57) ABSTRACT

The invention relates to a retail transaction system comprising a display module, a display module support, a bank payment reader, a bank payment reader support, a printer, a printer housing and a base arranged to be fixed to a payment counter, characterised in that the display module support, the bank payment reader support, the printer or the printer housing are removably affixed to the base. The invention includes a customer side and a merchant side, and at least one panel for displaying information, characterised in that the panels are removable and replaceable with an alternative panel showing different information. The invention can alternate between at least two viewing positions, a first position in which it can be viewed by the customer on one side of the counter, and a second position, in which it can be viewed by a merchant on the opposite side of the counter.

### FIELD OF INVENTION

This invention relates to retail transaction systems, including secured portable computation devices, such as a tablet computer, laptop or smart phone, an electronic mobile communication means such as Wi-Fi, satellite or telephone mobile network and a payment transaction means.

### BACKGROUND OF INVENTION

With increased competition from the online market place, it is becoming highly advantageous for high street outlets to improve flexibility and interactivity of the selling environment. With a high demand for information from the consumer it is in a merchant's best interests to display succinct and complete information about products in an easy and interactively accessible format. It is also increasingly in the interests of the merchant to improve marketing and the novelty of the selling process by taking advantage of new technologies and technological devices like social media and customer interactive software.

Furthermore, the demand for flexible retailing is increasing, merchants need to be able to take the point of sale to the customer, and provide supplementary marketing information. There is also a requirement for flexibility to help reduce queue build up during busy retailing hours.

With monthly changes to stock and seasonal marketing campaigns, it is important for a retailer to regularly review branding and advertising themes in store. In some cases this only requires the replacement of a poster or cardboard stand but in many cases is can be far more costly. Seasonal marketing or stock changes can happen as often as once a month and it can be very costly to change the themes around a large store or chain of stores. Furthermore, retailers occasionally require an entire identity change and go through complete rebranding, replacing logos and colour schemes throughout the organisation. This can often mean replacing expensive pieces of equipment which have been embossed with old colours or markings. There is therefore a requirement in this industry for flexibility and customisation. Offers and promotions with a high renewal rate require inexpensive solutions to broadcast their existence and availability so that changes and alterations to the current weekly discounts can be more affordable.

For small independent retailers there exists a need for inexpensive ways of identifying themselves from neighbouring competitors including small stores which are part of a larger retail complex and want their own entity to be more distinguished. With smaller turnovers and smaller branding budgets it is important for retailers like this to have an affordable and flexible method of advertising and branding within the store. It is also vital that this method be easily maintainable and convenient to use also with a relatively low maintenance cost.

Retailers with a nomadic business model are based on low overheads and high portability. These “pop-up shops” need an easily portable and relatively inexpensive solution to in shop branding, which can be changed, replaced and relocated depending on the requirements of the business. There is also a requirement for customisable and changeable advertising which can work within a small space and with minimal surfaces. This business model needs small convenient marketing methods which take advantage of small advertising spaces and utilize existing platforms and equipment surface space. This requirement is mainly driven by the restriction of portability, that there should not be further items or furniture which need to be carried around and setup. Furthermore, the advertising investment should be adaptable to seasonal changes and not need to be completely replaced.

Often, in the case of electrically powered equipment, when something goes wrong it is hard for the lay person to identify the fault. This is especially true when there are more than one electrically powered devices working together in a system, it is hard to know which device is faulty and what that fault is.

### SUMMARY OF INVENTION

According to a first aspect of the invention there is provided a retail transaction system comprising: a display module, a bank payment reading means and a base arranged to be fixed to a payment counter, with the display module is removably affixed to the base, and can alternate between at least two viewing positions, a first position in which it can be viewed by the customer on one side of the counter, and a second position, in which it can be viewed by a merchant on the opposite side of the counter.

The display module may include a tablet computer and a casing. The casing is arranged into mutually connecting parts covering the outer edge and rear side of the tablet computer to enable the display side of the tablet computer to be clear of any obstruction and to allow the display module to fix to the base. The bank card reading means can be attached to the casing on the opposite side to the display side of the tablet computer or on to the base using the same connecting means. Preferably, the tablet computer is in wireless communication with a computer network, which transfers the transaction details and also serves to update product information.

The system includes a base for fixing the display module onto a retail counter. The base provides a hinge to alternate the viewing position of the display module between customer facing and merchant facing configurations. The base could also provide a power supply to replenish the tablet computer battery and data communication means for updating and back-up when the wireless communication is not available. The base could also provide a power supply to replenish a payment reader battery. The display casing and the bank card reading means are preferably lockable in the base for security to prevent unauthorised removal. Preferably, the removable attachment means are provided in the form of corresponding sliding surfaces on the base, the casing and on a housing of the card reader.

The base may include automatic data connection means to enable data communication between the card reader and the table computer when the card reader is in the fitted position on the base.

The mutually connecting parts include a male and a female sliding part. The male connecting part of the card reader is removably attached to the female part of the rear of the casing of the display module. The card reader male attaching means is also attachable to the base female attaching means. The male and female sliding parts may comprise a square-shaped slot corresponding to a similarly shaped protrusion; this allows the male part to slot in and slide along inside the female part and abut along the length of the inner female connecting part. When in fixed connection the male connecting part cannot be removed from the female connecting part with reversing the sliding connecting process.

The casing of the tablet computer comprises a first, second side parts and rear part. The first and second side parts are preferably connected to the rear part by corresponding interlocking slots and a retaining screw. The casing is removable to enable the tablet computer to be replaced, however whilst the tablet computer and the casing are in the base the casing is preferably secured by a locking mechanism. Consequently, the casing cannot be removed from the tablet computer while they are stowed in the base.

Furthermore, the bank payment reading means is engaged on the display module such that it must slide sideways relative to the casing in order to be removed.

According to a further aspect of the invention there is provided a retail transaction system comprising: a display module, a bank payment reading means, a base arranged to be fixed to a payment counter, and including a customer side and a merchant side, and at least one panel for displaying information, characterised in that the system panels are removable and replaceable with an alternative panel showing different information.

The display module may be removably affixed to the base and the panels may be removably attached to at least one surface of the display module. The base may be comprised of enlarged surfaces for securing the panels. The panels may be attached to the base or display module by detents, by hook and loop fasteners or by an adhesive. The base preferably includes elongated rectangular sections which extend vertically and may attach to the display module on the merchant side and the bank payment reading means on the customer side. These elongated rectangular sections may include angled parts to provide angled surfaces and each preferably forms a surface for attaching a respective panel. Preferably, at least one of the enlarged surfaces of the base is angled towards either the merchant or the customer. The enlarged surface may be an inverted U shape with sides angled outwards from the top part with all three sides having a surface for receiving a panel. The rectangular sections may include an angled portion.

Preferably the display module can alternate between at least two viewing positions, a first position in which it can be viewed by the customer on one side of the counter, and a second position, in which it may be viewed by a merchant on the opposite side of the counter. The display module may be rotatably movable, between the first and second positions and is rotatable by preferably at least 20 degrees. The display module may be removably attachable to the base, by removable attachment means. The base may include a display module connecting means which may include a hinge which includes stops to limit the range of rotation of the display module. The bank payment reading means may also be removably fixed to the base by removable attachment means and the display module and the bank payment means may be fixable to each other.

Furthermore, the tablet computer is preferable in wireless communication with a computer network, which transfers the transaction details and also serves to update product information.

The current invention preferably comprises a display module, a display module support, a bank payment reading means, a bank payment reader support, a printer, a printer housing and a base arranged. The base is preferably fixed to a payment counter, with at least one of, the display module support, the bank payment reader support, the printer and the printer housing all being removably affixed to the base.

The present invention preferably have the display module, bank payment reading means and printer all interconnected such that if there is a fault or a battery is low this is detectable and can be indicated via the display module, or a separate display on the base.

The display module may be in wireless communication with at least one of the bank card reading means and the printer. Furthermore, the display module may also be rotatably movable, between a first merchant facing position and a second customer facing position. This rotation may be by at least 20 degrees.

The display module is preferably removably attachable to the display module support, by removable attachment means. The display module may also include a battery to allow wireless functionality.

The bank card reading means is also preferably removably attachable to the bank card reader support, by removable attachment means. The display module support may include a display module connecting means which may include a hinge. This hinge would preferably include stops to limit the range of rotation of the display module.

The bank payment reading means may be removably fixed to the bank payment reader support by removable attachment means.

The display module and the bank payment means may include mutually cooperative attachment means to enable them to be fixable to each other.

Preferably, at least one of the display module support and the bank payment reader support are adjustable in height.

According to a further aspect of the present invention the tablet computer may be in wireless communication with a computer network, which could transfer the transaction details and also serves to update product information.

The display module may also include a display casing which is lockable via a latching means in the base for security to prevent unauthorised removal.

The base may include automatic data connection means to enable data communication between the bank payment reading means, the display module and the printer when they are interconnected.

The base is preferably attached to the counter by a single lead which provides power, data connectivity and security from theft.

The retail transaction system may include at least one panel for displaying information. These panels may be removable and replaceable with an alternative panel showing different information. These at least one panel may be removably affixed to the base.

### BRIEF DESCRIPTION OF DRAWINGS

FIG. 1: Shows a perspective view of a first embodiment of the retail transaction system assembly.

FIG. 2: Shows a perspective view of a first embodiment of the retail transaction system assembly in the customer facing configuration.

FIG. 3: Shows a side view of a first embodiment of the retail transaction system assembly in the customer facing configuration.

FIG. 4: Shows a perspective view of the base of a first embodiment.

FIG. 5: Shows a side view of the base of a first embodiment.

FIG. 6: Shows an enlarged perspective view of the first base connecting means of a first embodiment.

FIG. 7: Shows an enlarged perspective view of the second base connecting means of a first embodiment.

FIG. 8: Shows a perspective view of the unconnected mobile transaction module, with the display module and bank card reading means of a second embodiment shown separately.

FIG. 9: Shows a perspective view of the connected mobile transaction module of the second embodiment.

FIG. 10: Shows an exploded rear view of the casing of the third embodiment.

FIG. 11: shows an alternative perspective view of the fourth embodiment of the retail transaction system assembly of the invention,

FIG. 12: shows a perspective view of an alternative embodiment of the retail transaction system assembly of the invention,

FIG. 13: shows a perspective view of the display module of the retail transaction system of FIG. 11,

FIG. 14: shows a perspective view of a further alternative embodiment of the retail transaction system assembly,

FIG. 15: shows a perspective view of the retail transaction system assembly of FIG. 14 in a customer facing configuration, and

FIG. 16: shows a side view of the retail transaction system assembly of FIG. 14 in the customer facing configuration.

FIG. 17: Shows a perspective view of a further alternative embodiment of the retail transaction system of the invention in the customer facing configuration, at a point of sale,

FIG. 18: Shows a perspective reverse view of the retail transaction system of FIG. 17 in the customer facing configuration.

FIG. 19: Shows a side view of the retail transaction system of FIG. 17 in the merchant facing configuration.

FIG. 20: Shows an exploded view of the components of the retail transaction system, of FIG. 17.

FIG. 21: Shows a view of the modular printer housing, of FIG. 17.

FIG. 22: Shows a view of the base, of FIG. 17.

FIG. 23: Shows an enlarged perspective view of the bank card reader support, of FIG. 17.

FIG. 24: Shows a perspective view of the bank payment reading means disconnected form the support, of FIG. 17.

FIG. 25: Shows a perspective view of the display module of FIG. 17 disconnected from the support.

### DETAILED DESCRIPTION

In this description the reference numbers for common parts remain the same throughout the various embodiments.

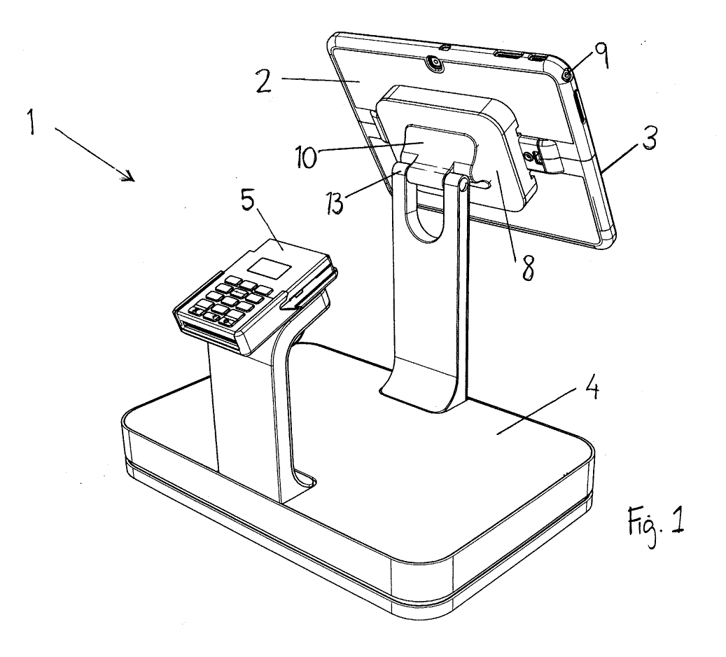

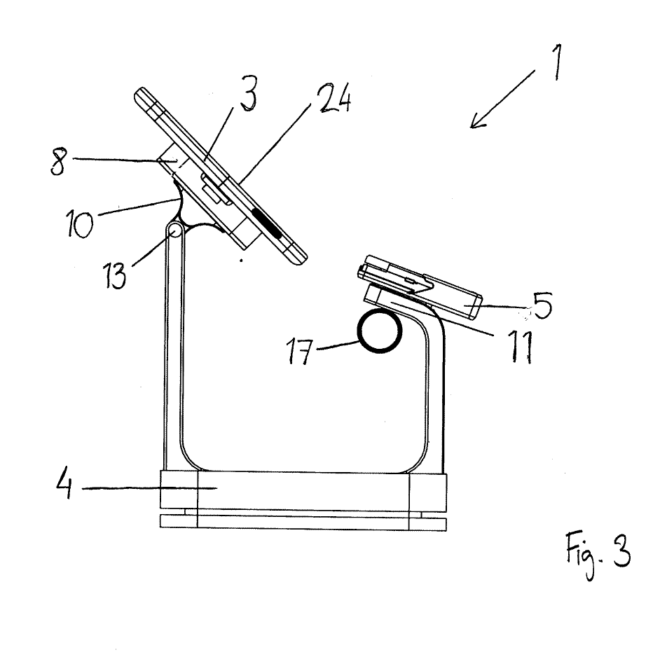

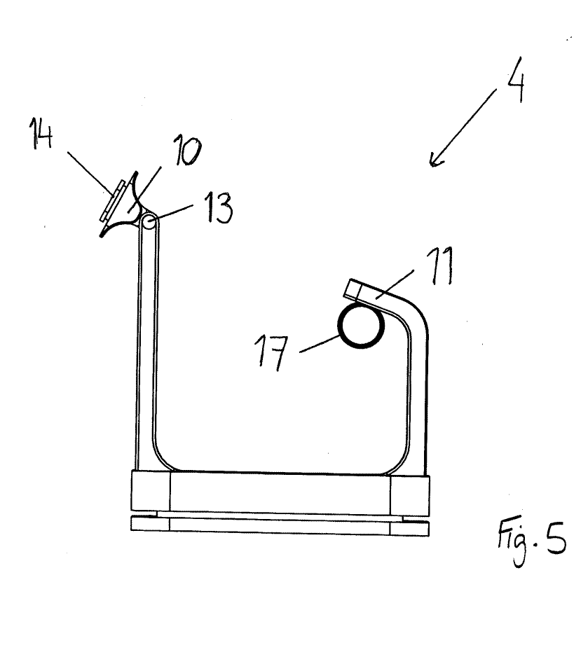

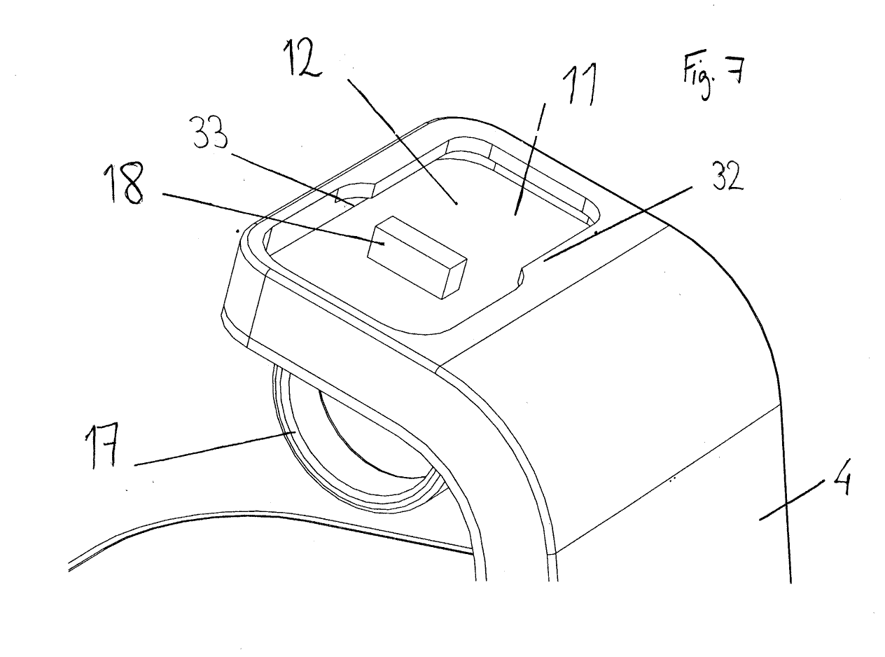

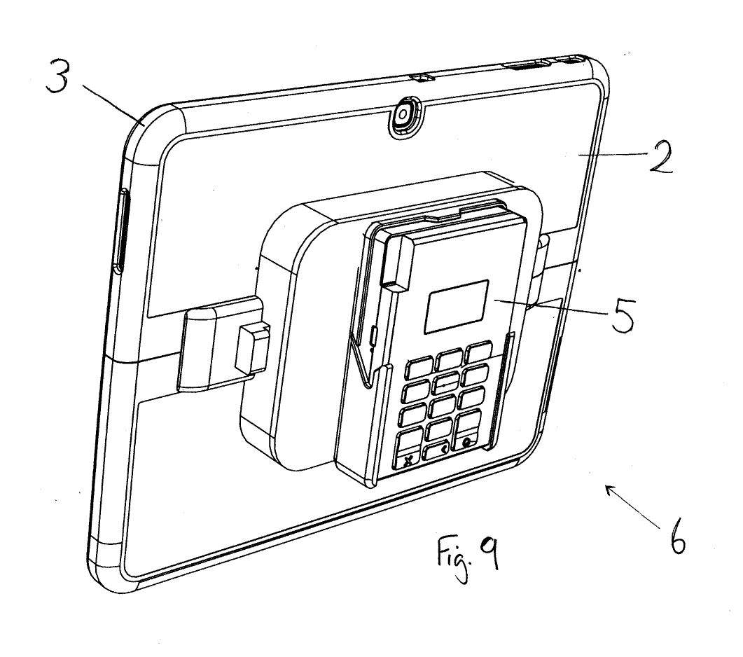

Referring now specifically to FIG. 1 to FIG. 10: In one embodiment of the invention, shown in FIG. 1 to FIG. 9, there is provided a retail transaction system 1 comprising a display module 3 comprising a casing 2 which encloses a tablet computer 9 including a display for displaying product or service information attached to a first base connecting means 10, of a base 4. Directly opposite the display module 3 is a bank card reading means 5 connected to a second base connecting means 11. The bank card reading means 5 is in data communication with the tablet computer 9 such that items selected from the display can be paid for by a customer by use of the bank payment reading means 5 debiting the customers bank account. The card can be either a debit card, a credit card, or a cash card, or alternatively or additionally a chip and pin reader. The base 4 is fixedly secured to the counter such that the retail transaction system 1 can be used in a retail environment with a customer on one side of the counter (not shown) facing the bank card reader means 5 and the merchant on the other side of the counter (not shown) facing the display module 3.

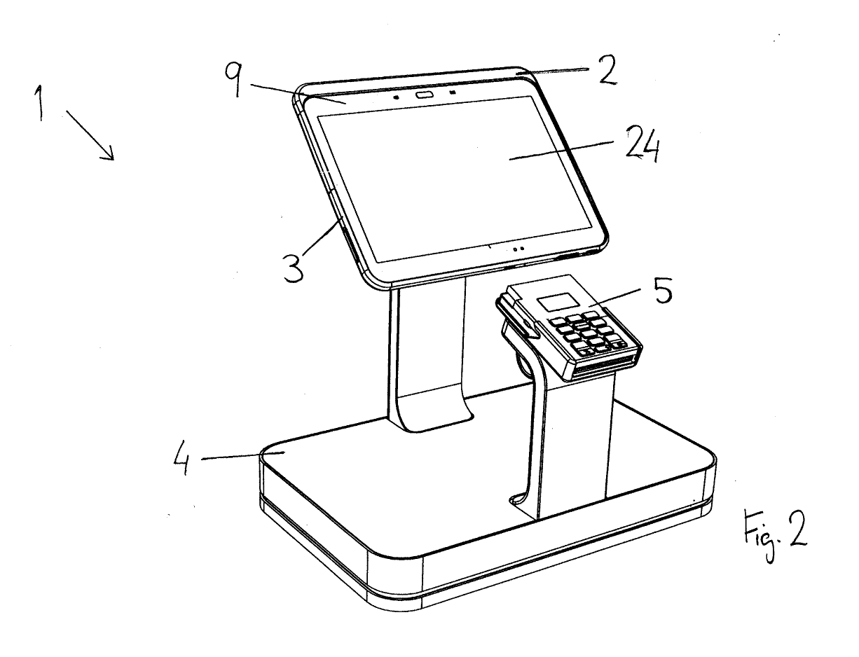

The casing 2 covers the back and the perimeter of the tablet computer 9, leaving the front of the display module 3 exposed to allow the display side 24 of the tablet computer 9 to be viewed. The back of the casing 2 is attached to the base 4 by a first base connecting means 10, which is attached to the base 4 by hinge 13. The hinge 13 allows the display module 3 to alternate between a customer facing configuration (FIG. 2) and a merchant facing configuration (FIG. 1), by rotating around the hinge 13 relative to the base 4. This allows the merchant to easily display merchandise on the display unit to the customer in the customer facing configuration and also carry out a purchase or other transaction in the merchant facing configuration.

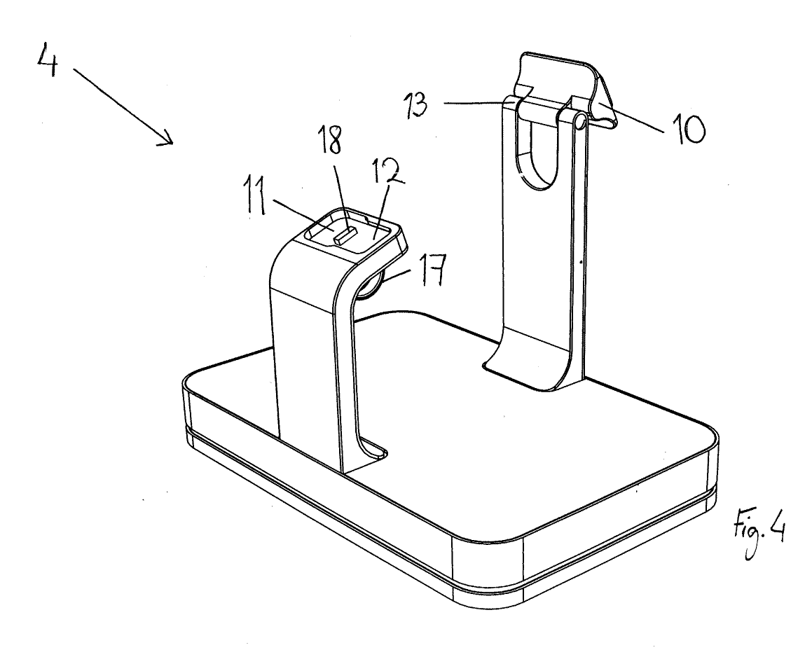

The casing 2 attaches to the display module connecting means 8 which allows the display module 3 to be removably attached to the base 4 and the bank payment reading means 5. The bank payment reading means 5 is attachable to the casing 2 on the rear side of the display module 3 and to the base 4 by the second base connecting means 11. The bank payment reading means 5 and the display module 3 are able to disengage the base 4 and be used wirelessly; the bank payment reading means 5 and the display can be used simultaneously. The display module 3 and the bank payment reading means 5 can receive power and be recharged and also remain secure and protected from theft while attached to the base 4. There is also preferably at least one USB ports (not shown) provided on the base 4 to provide power and connectivity to optional peripheral devices such as printers or scanners (not shown). The card reader connecting means 7 includes a locking means 18, releasable by a latch 17 which is accessed by the retail merchant, as shown in FIG. 4. The merchant can use the display module 3 to display a variety of product information and marketing material using suitable known software and in this way provide the customer with a more satisfying and informed retailing experience. Through the use of price or product comparison with other competitors the merchant can also provide the customer with the best opportunity and a positive retail experience. The display is ideally a touch screen display with a digitising layer to permit easier interaction between the merchant or customer and the tablet computer 9.

Preferably the tablet computer 9 is also in wireless communication with a computer network to transfer and approve transaction details and update product information.

To attach the bank card payment means 5 the merchant locates the interlocking tongue 14 in the interlocking slot 12 and slides the bank payment reader means 5 across so that the interlocking tongue 14 slides into the grooves 33 and engages the flanges 32 which hold the interlocking tongue 14 in place. The interlocking tongue 14 is prevented from sliding back out of the groove 33 by the locking means 18.

The locking means consists of a spring loaded detent which is depressed by the locking latch 17 in order to remove the interlocking tongue 14 from the groove 33.

The casing 2 corresponds to the shape of the tablet computer 9 but fixes to display module connecting means 8 using a standard fitting so that alternative tablet computer models with respective casings can be attached to the base 4 by the display module connecting means. The base casing 2 will be dedicated to the model of the tablet computer 9, but it is possible for the base 4 to accommodate alternative models through the use of display module connecting means. Preferably the base station 4 provides a power connection for replenishing the battery of the display module 3 and data communication means for backup and update when wireless communication is not possible and when the display module 3 and bank payment reader means 5 are connected to the base 4. The tablet computer 9 connects to the bank payment reader means wirelessly. The base 4 then connects to a separate computer network (not shown) via an external USB connection means (not shown). The base 4 may be securely fastened to a fixed surface via retaining screws through dock-to-surface retaining screw holes (not shown); these are inaccessible whilst the base is engaged with the counter (not shown). Whilst the display module 3 is engaged with the base 4 it can still be used as a traditional fixed till and is preferably lockable and cannot be removed without merchant approval, using a key inserted into a key hole (not shown), for security purposes.

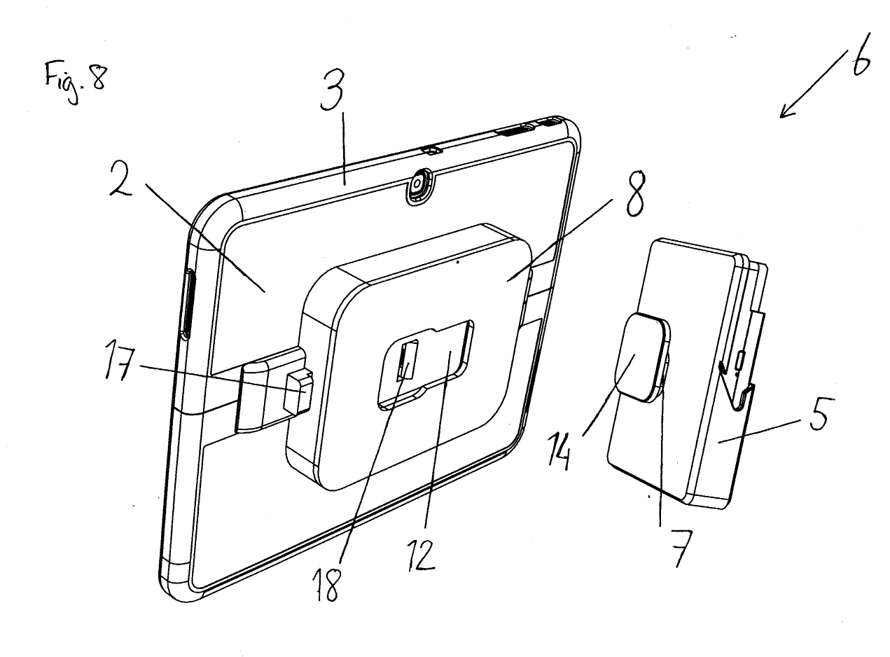

Referring in particular to FIG. 8 the bank payment reader 5 shown removed from the display module 3. The reader 5 is removably attached to the display module 3 by means of interlocking tongue 14 on the bank payment reader 5 and a corresponding interlocking slot 12 on the display module. Both the bank card reading means 5 and the display module 3 can be used whether or not they are attached to each other or the base 4.

Referring still to FIG. 8, the casing 2 is made up of three parts, the first side part 19, the second side part 21 and the rear part 23. The first and second side parts 19, 21 slide on to the tablet computer 9 and abut together to encase the tablet computer 9.

The first and second side parts 19, 21 have corresponding interconnecting tongs and grooves 27 located on the rear of the display module 3, which interconnect as the two parts come into contact. The mating of the tong and grooves provide added flexural rigidity. The rear part 23 then slides over corresponding sliding surfaces 26 on the two side parts to secure all three pieces together. All three pieces are then held in place with a single retaining screw 28. The process is reversed in order to remove the tablet for repair, replacement or upgrade.

The retaining screw head is provided on the rear side of the casing 2 on the rear part 23 and when fastened is countersunk into all three casing parts 19, 21, 23. Once the display module 3 is in the base 4 the rear part 23 is covered. Consequently the casing 2 may not be removed without first removing the display module 3 from the base 4. The casing parts 19, 21, 23 and the bank card reading means 5 are all made from a sufficiently robust material, preferably a polycarbonate to protect from accidental damage or tampering.

Referring now to FIGS. 4, 6 and 8, the locking means 18 locks the bank payment reading means 5 and the display module 3 into the base 4, and to each other when in the mobile configuration, to prevent against theft. The locking means 18 is controlled by a locking latch 17 which, in locked position, retains against the interlocking tongue on the card reader connecting means 7 of the bank card reading means 5. This prevents unauthorised removal of the bank card reading means 5.

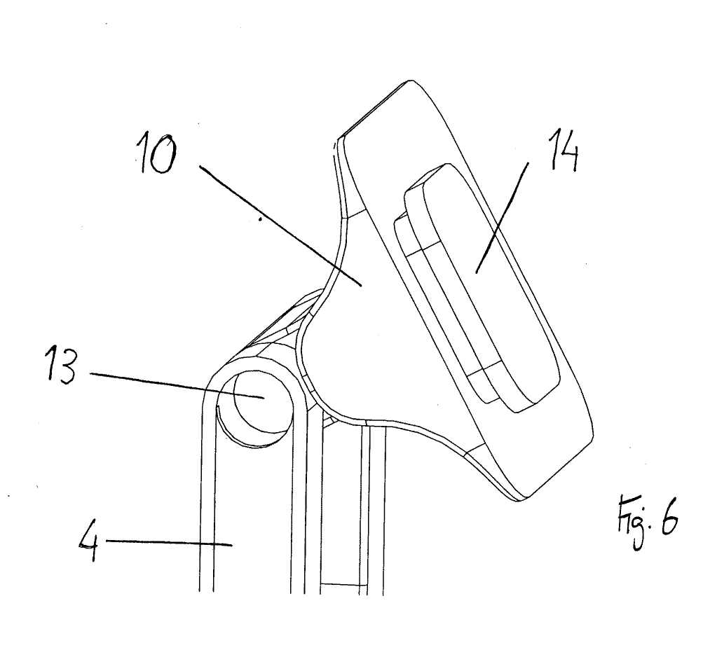

Referring to FIGS. 6, 7 and 8, the bank payment reading means 5 is removably attached to the base 4 or, alternatively the display module 3. The display module 3 and the bank payment reading means 5 attach to the base 4 and together by means of a mutual sliding tongue and slot mechanism. The tongue 14, being a constituent of the first base connecting means 10 and the card reader connecting means 7 which is in turn a constituent of the bank card reading means 5 not only allows for easy removal but also permits flexibility in the type and size of the attached bank payment reading means 5. The bank card reading means 5 or the base 4 and the display module 3 attach together by means of the same mutual sliding tongue and slot mechanism. The slot, being a constituent of the display module connecting means and the second base connecting means, not only allows for easy removal but also permits flexibility in the type and size of the attached display module 3. The display module 3 and the bank card reading means 5 are locked in place by the locking means 18, a constituent of the display module connecting means and the second base connecting means.

It will be appreciated that the term tablet computer 9 can include any computing device which includes a display that is large enough to effectively display products or services in a retail environment and includes suitably adapted notebooks or laptops and the like.

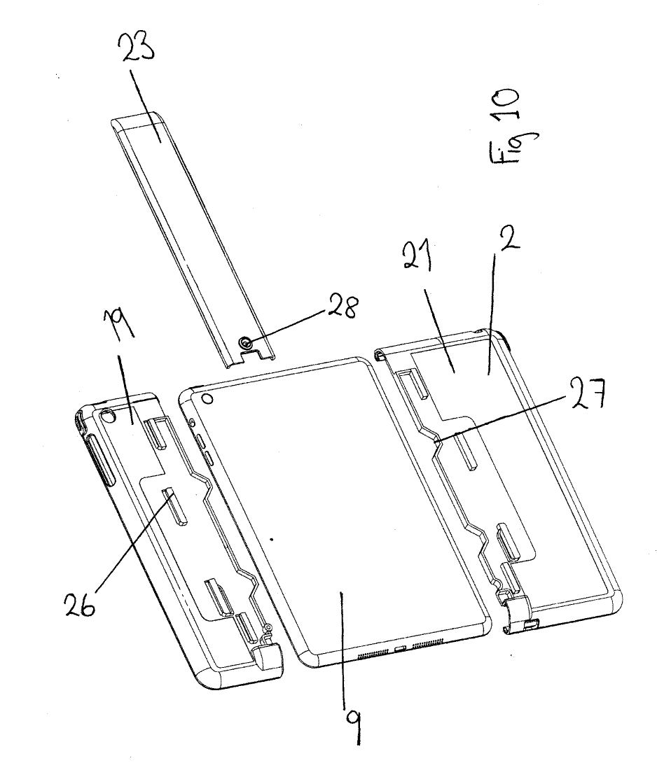

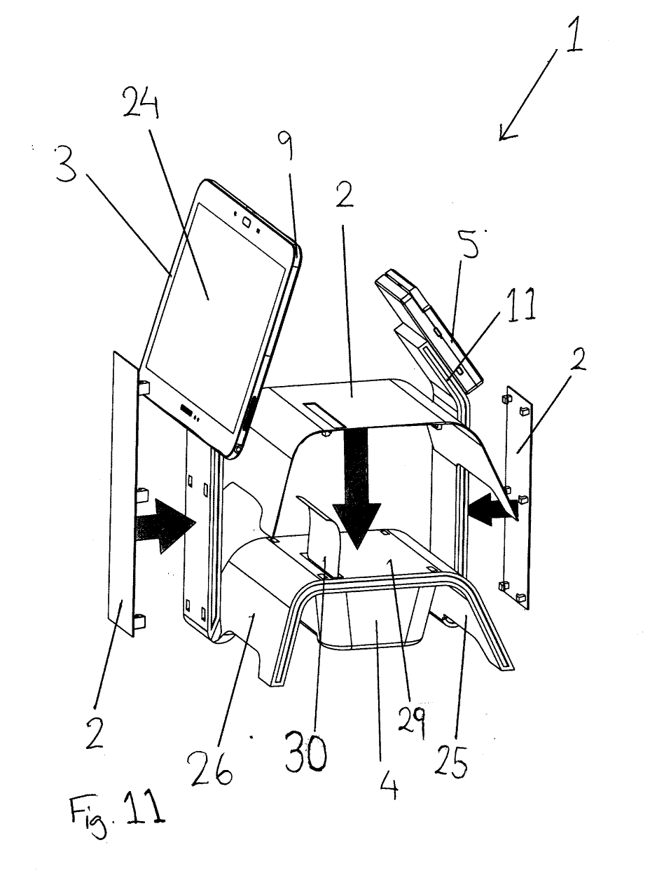

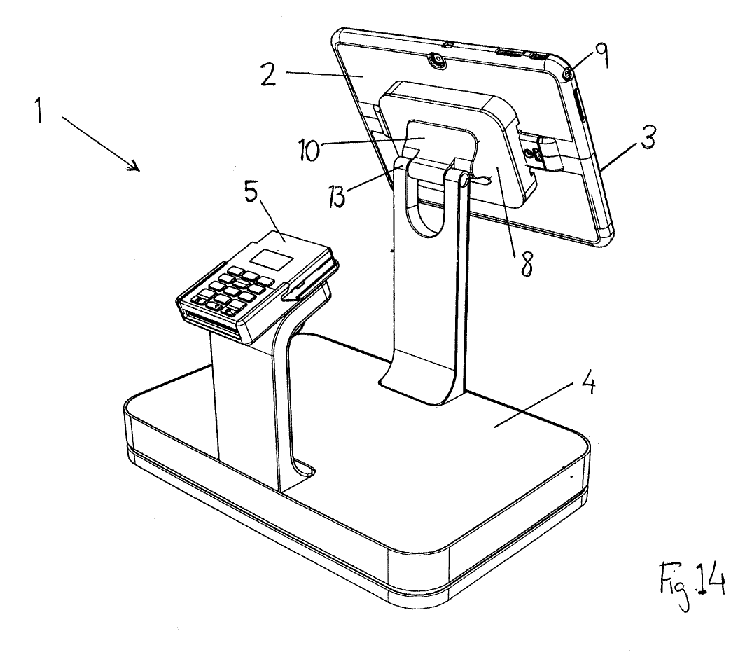

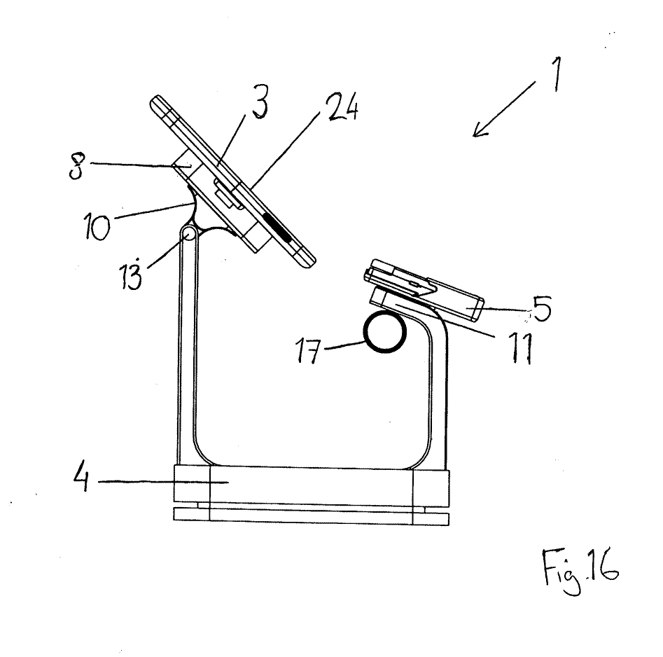

Referring now specifically to FIG. 11 to FIG. 16: In a second embodiment of the invention, shown in FIG. 10, there is provided a retail transaction system 1 comprising a display module 3, a bank payment reading means 5, and base 4. The base 4 includes several information panels 20 which are attached to it. The display module 3 includes a tablet computer 9 and a display side 24 for displaying product or service information and is attached to a first base connecting means 10, of a base 4. Directly opposite the display module 3 is a bank card reading means 5 connected to a second base connecting means 11. The bank card reading means 5 is in data communication with the tablet computer 9 such that items selected from the display can be paid for by a customer by use of the bank payment reading means 5 debiting the customers bank account. The card can be either a debit card, a credit card, or a cash card, or alternatively or additionally a chip and pin reader. The base 4 is fixedly secured to the counter such that the retail transaction system 1 can be used in a retail environment with a customer on one side of the counter (not shown) facing the bank card reader means 5 and the merchant on the other side of the counter (not shown) facing the display module 3.

In the embodiment shown in FIG. 10 the base has an inverted U shape, with angled sides 6 and 7 which angle outwardly from a top surface 29 to provide a stable support and an enlarged surface to affix an information panel 20. The customer facing side 25 and the merchant facing side 7 face opposite directions and are angled upwards towards the line of sight of either the customer or merchant. Information on the panels 2 could, for example, identify an independent merchant within a larger store or be easily replaced in the case where the in-store merchant changes.

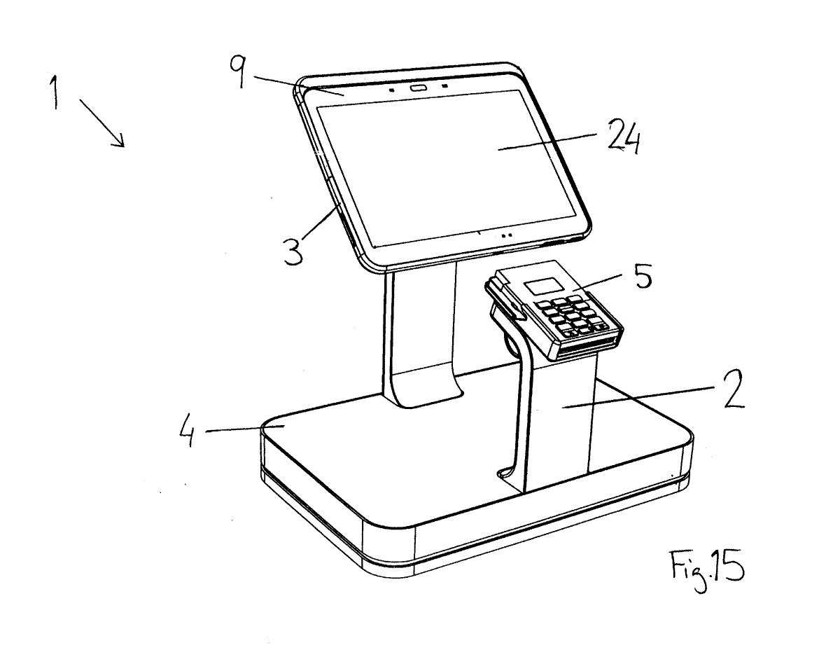

The information panels 20 cover the top side of the base 4, the back side of the display module 3 and both the customer facing side 25 and the merchant facing side 26 of the retail transaction system 1; allowing the marketing or advertising material to be viewable from all angles during normal use. The back of the display module 3 attaches to the base 4 by a first base connecting means 10, which is attached to the base 4 by hinge 13. The hinge 13 allows the display module 3 to alternate between a customer facing configuration (FIG. 15) and a merchant facing configuration (FIG. 10), by rotating around the hinge 13 relative to the base 4. This allows the merchant to easily display merchandise on the display unit to the customer in the customer facing configuration and also carry out a purchase or other transaction in the merchant facing configuration.

The display module 3 includes a display module connecting means 8 which allows the display module 3 to be removably attached to the base 4 and the bank payment reading means 5. The bank payment reading means 5 is attachable to the display module 3 on the rear side of the display module 3 and to the base 4 by the second base connecting means 11. The bank payment reading means 5 and the display module 3 are able to disengage the base 4 and be used wirelessly; the bank payment reading means 5 and the display can be used simultaneously. The display module 3 and the bank payment reading means 5 can receive power and be recharged and also remain secure and protected from theft while attached to the base 4. There is also preferably at least one USB ports (not shown) provided on the base 4 to provide power and connectivity to optional peripheral devices such as printers 30 or scanners (not shown). The merchant can use the display module 3 to display a variety of product information and marketing material using suitable known software and in this way provide the customer with a more satisfying and informed retailing experience. Through the use of price or product comparison with other competitors the merchant can also provide the customer with the best opportunity and a positive retail experience. The display is ideally a touch screen display with a digitising layer to permit easier interaction between the merchant or customer and the tablet computer 9.

Preferably the tablet computer 9 is also in wireless communication with a computer network to transfer and approve transaction details and update product information.

To attach the information panels 20 the merchant locates the interlocking tongue 14 in the interlocking slot 12 and presses the information panel 20 so that the interlocking tongue 14 clips into the interlocking slot 12 and engages the recess 22 which hold the interlocking tongues 14 in place.

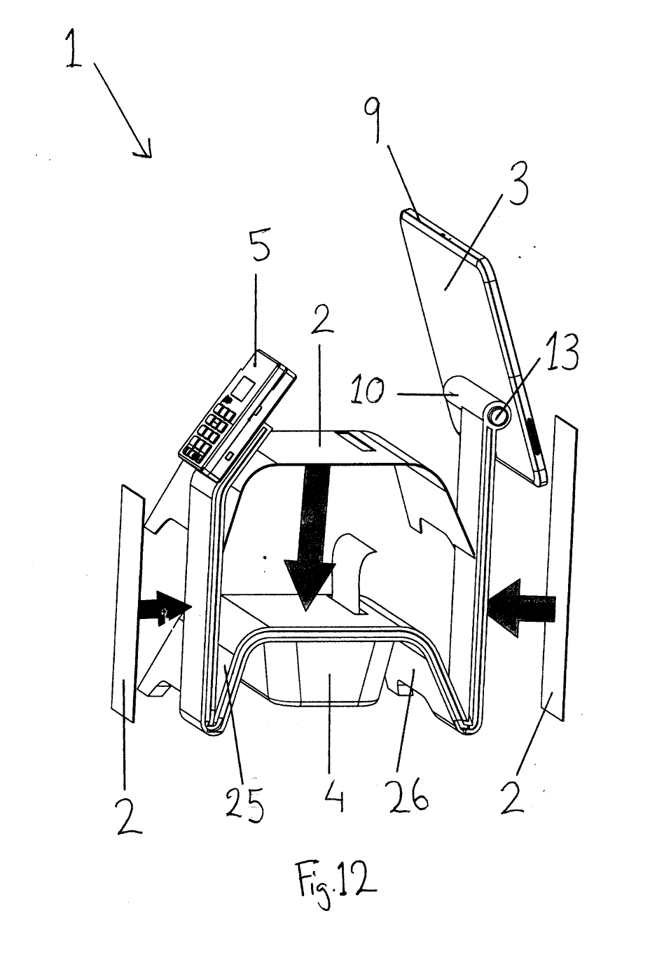

FIG. 12 shows an alternative embodiment of the invention which uses an adhesive to affix the information panels 20 to the base 4 and display module 3 instead of the interlocking tongue and slot mechanism as referred to above.

The information panels 20 correspond to the shape of their respective location on the retail transaction system 1 so as to cover the surface edge to edge. The information panels 20 affix using a standard fitting so that alternative information panels 20 can be removed and replaced. The information panel 20 which affixes to the back of the display module will be dedicated to the model of the tablet computer 9, but it is possible for the base 4 to accommodate alternative models through the use of display module connecting means 8. Preferably the base station 4 provides a power connection for replenishing the battery of the display module 3 and data communication means for backup and update when wireless communication is not possible and when the display module 3 and bank payment reader means 5 are connected to the base 4. The tablet computer 9 connects to the bank payment reader means wirelessly. The base 4 then connects to a separate computer network (not shown) via an external USB connection means (not shown). The base 4 may be securely fastened to a fixed surface via retaining screws through dock-to-surface retaining screw holes (not shown); these are inaccessible whilst the base is engaged with the counter (not shown). Whilst the display module 3 is engaged with the base 4 it can still be used as a traditional fixed till and is preferably lockable and cannot be removed without merchant approval, using a key inserted into a key hole (not shown), for security purposes.

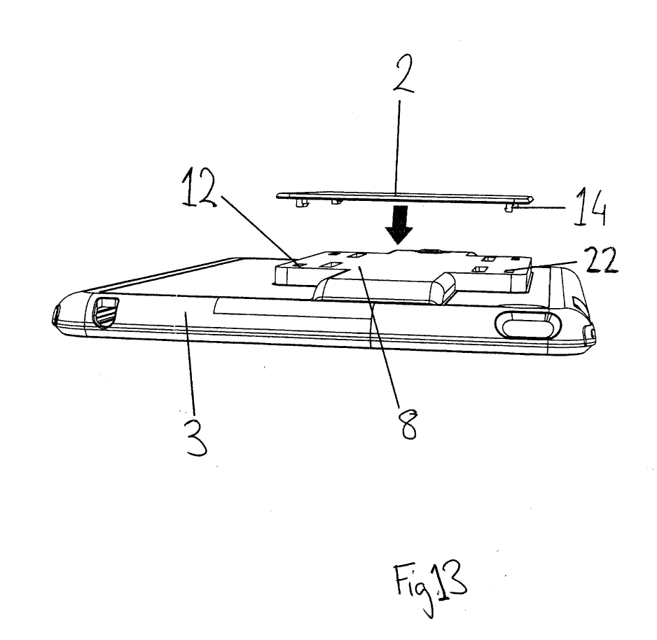

Referring in particular to FIG. 13 the information panel 20 is shown removed from the display module 3. The display module 3 is removably attachable to the bank payment reading means and the first base connecting means 10 by means of display module connecting means 8 on the back of the display module 3. Both the bank card reading means 5 and the display module 3 can be used whether or not they are attached to each other or the base 4.

The information panels 20 are all made from a sufficiently robust material, preferably a polycarbonate to protect from accidental damage or tampering.

The bank payment reading means 5 is removably attached to the base 4 or, alternatively the display module 3. The display module 3 and the bank payment reading means 5 attach to the base 4 and together by means of a mutual sliding tongue and slot mechanism. The tongue (not shown), being a constituent of the first base connecting means 10 and the card reader connecting means (not shown) which is in turn a constituent of the bank card reading means 5 not only allows for easy removal but also permits flexibility in the type and size of the attached bank payment reading means 5. The bank card reading means 5 or the base 4 and the display module 3 attach together by means of the same mutual sliding tongue and slot mechanism. The slot, being a constituent of the display module connecting means and the second base connecting means, not only allows for easy removal but also permits flexibility in the type and size of the attached display module 3. The display module 3 and the bank card reading means 5 are locked in place by the locking means 18, a constituent of the display module connecting means and the second base connecting means.

It will be appreciated that the term tablet computer 9 can include any computing device which includes a display that is large enough to effectively display products or services in a retail environment and includes suitably adapted notebooks or laptops and the like.

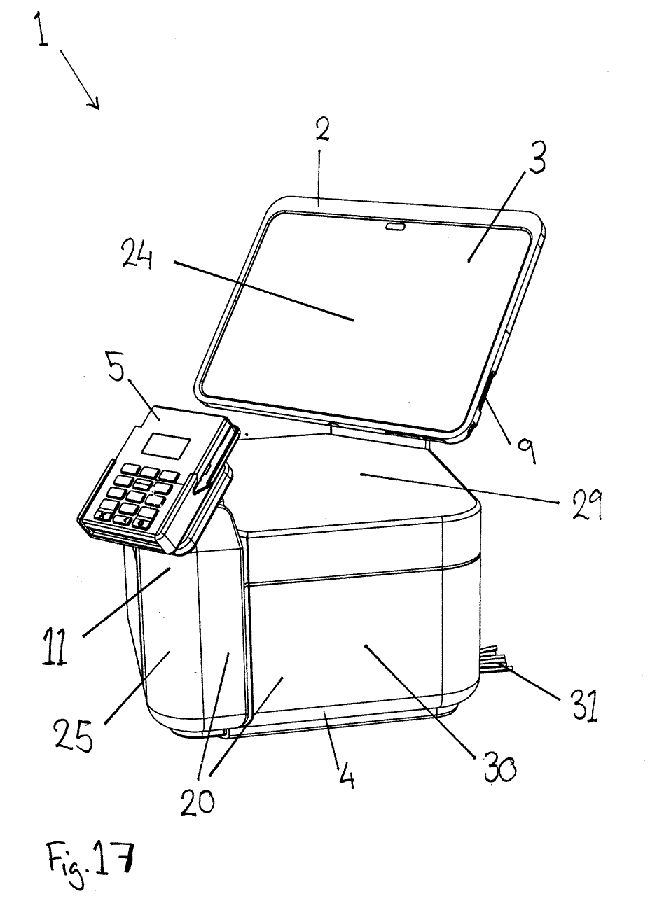

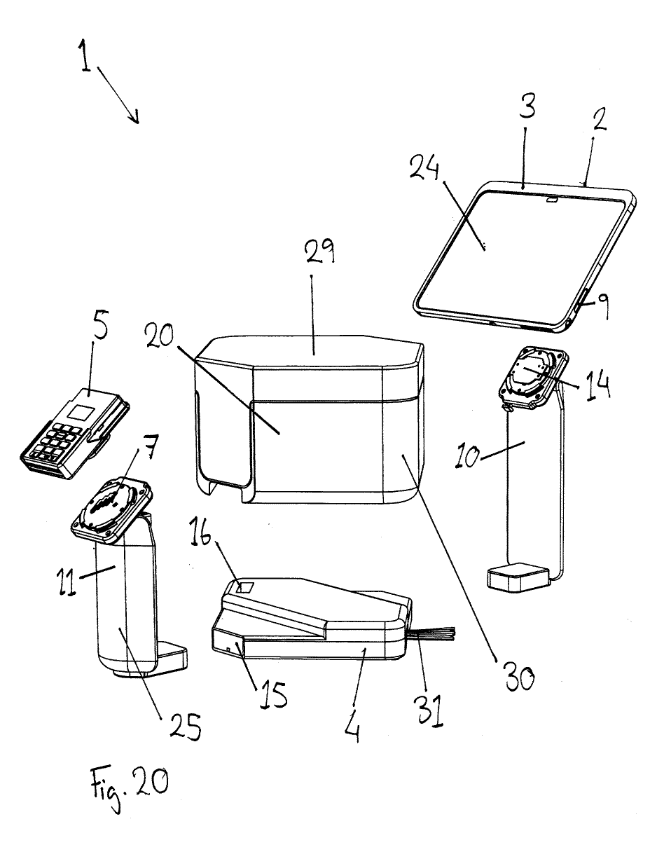

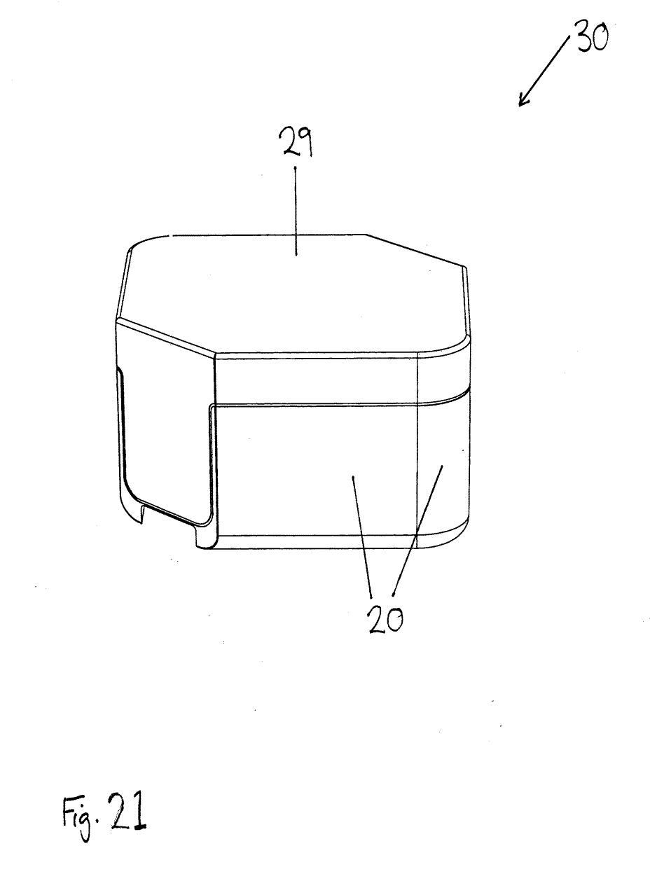

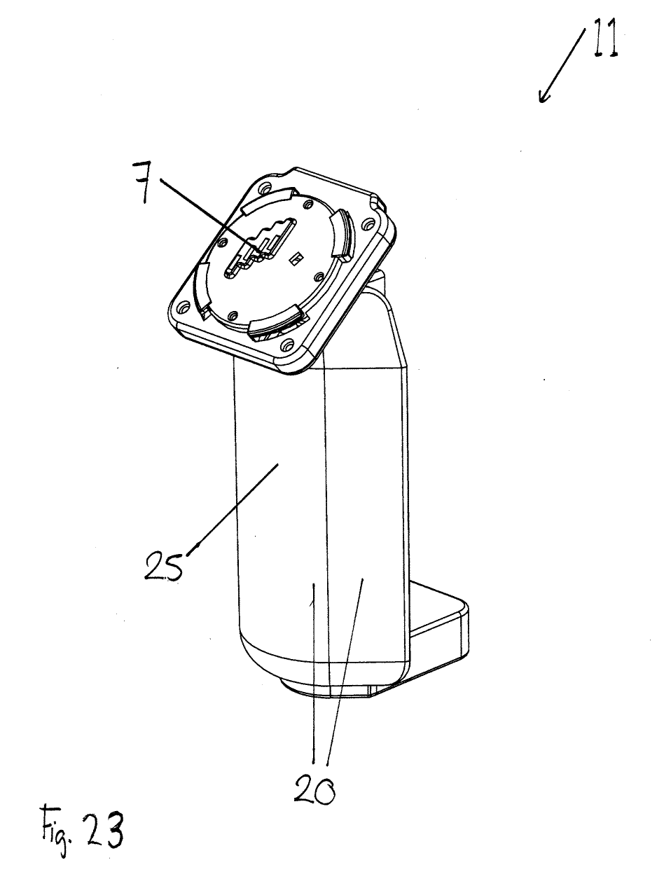

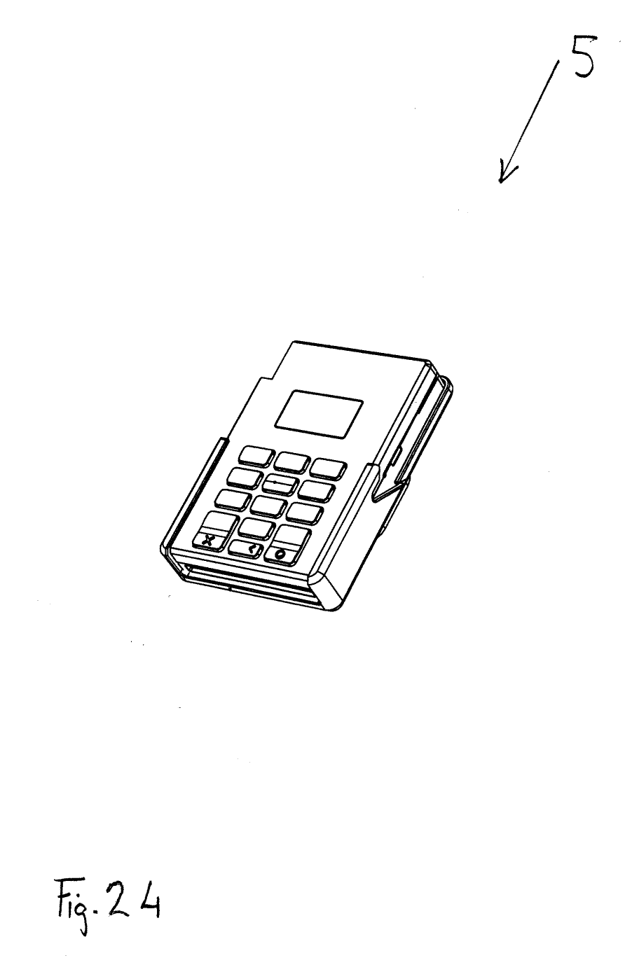

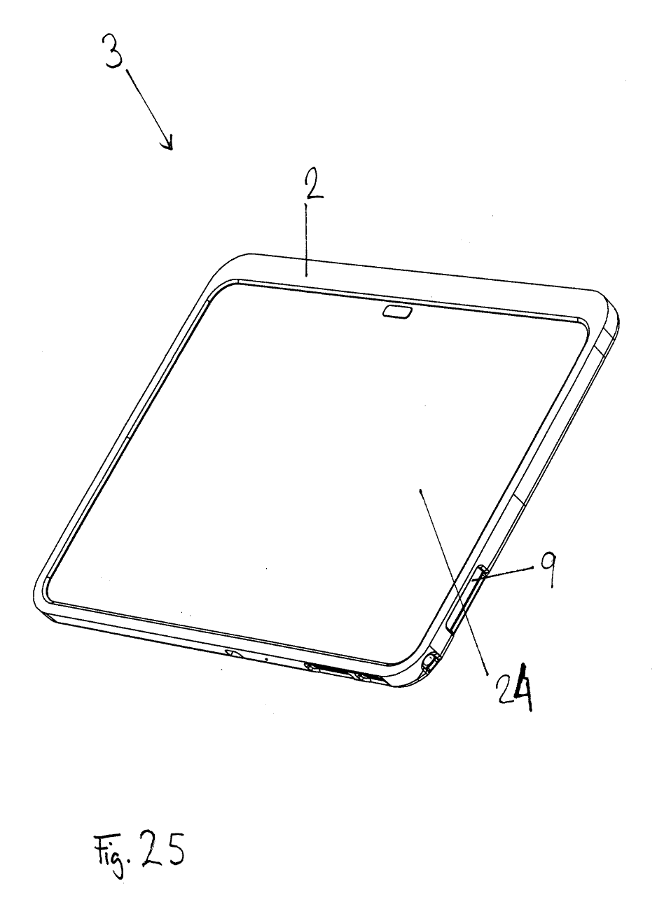

Referring now specifically to FIG. 17 to FIG. 25: In an alternative embodiment of the invention, shown in FIG. 17, there is provided a retail transaction system 1 comprising a display module 3 a display module support 10, a bank payment reading means 5, a bank payment reader support 11, a printer (not shown), a printer housing 30 and base 4. The base 4 includes several information panels 20 which are attached to it. The display module 3 includes a tablet computer 9 and a display side 24 for displaying product or service information and is attached to a display module support 10, which is attached to a base 4. Directly opposite the display module 3 is a bank card reading means 5 connected to a bank payment reader support 11. The bank card reading means 5 is in data communication with the tablet computer 9 such that items selected from the display can be paid for by a customer by use of the bank payment reading means 5 debiting the customers bank account. The card can be either a debit card, a credit card, or a cash card, or alternatively or additionally a chip and pin reader. The printer (not shown) is in the printer housing 30 is located in the area between the display module 3 and the bank card reading means 5 removably fixed directly on top of the base 4. The base 4 is fixedly secured to the counter such that the retail transaction system 1 can be used in a retail environment with a customer on one side of the counter (not shown) facing the bank card reader means 5 and the merchant on the other side of the counter (not shown) facing the display module 3.

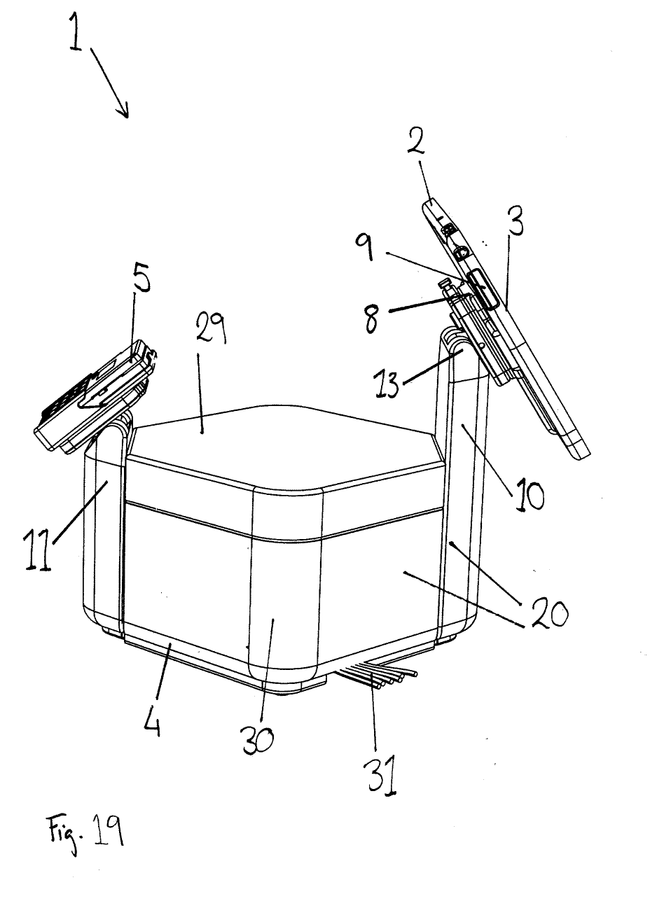

In the embodiment shown in FIG. 19 the base has a cuboid shape, with angled sides 25, 26 and 29 which angle outwardly to provide an enlarged surface to affix an information panel 20. The customer facing side 25 and the merchant facing side 26 face opposite directions and are angled towards the line of sight of either the customer or merchant respectively. Information on the panels 20 could, for example, identify an independent merchant within a larger store and can be easily replaced when the in-store merchant changes.

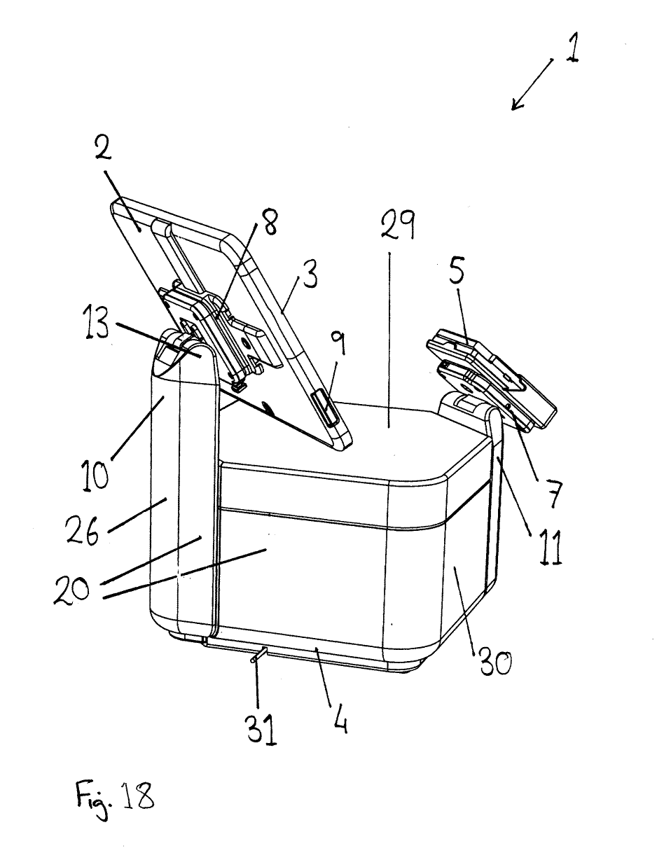

The information panels 20 cover the top side of the printed 30, the back side of the display module 3 and both the customer facing side 25 and the merchant facing side 26 of the retail transaction system 1; allowing the marketing or advertising material to be viewable from all angles during normal use. The back of the display module 3 attaches to the display module support 10 by hinge 13, which is attached to the base 4. The hinge 13 allows the display module 3 to alternate between a customer facing configuration (FIG. 18) and a merchant facing configuration (FIG. 19), by rotating around the hinge 13 relative to the base 4. This allows the merchant to easily display merchandise on the display unit to the customer in the customer facing configuration and also carry out a purchase or other transaction in the merchant facing configuration. Furthermore, the display module support 10 and bank card reader support 11 can be adjusted in height allowing flexible adjustment for customer and merchant ease of use.

The display module 3 includes a display module connecting means 8 which allows the display module 3 to be removably attached to the base 4 and the bank payment reading means 5. The bank payment reading means 5 is attachable to the display module 3 on the rear side of the display module 3 and to the base 4 by the second base connecting means 11. The bank payment reading means 5 and the display module 3 are able to disengage the base 4 and be used wirelessly; the bank payment reading means 5 and the display can be used simultaneously. The display module 3 and the bank payment reading means 5 can receive power and be recharged and also remain secure and protected from theft while attached to the base 4.

The display module 3, the bank payment reading means 5 and the printer all receive power and a data connection from the base 4. The base 4 in turn is physically connected to the internet and a mains power supply by a connecting means 31. This connecting means 31 includes a data connection, a power connection and a security tether all attached in one position on the base 4. The tether, power cable and data cable attach to the base in one place to reduce the number of cables to a single conduit and also the number of cable ports; this is important in a retail environment to reduce the health and safety hazard that excessive cabling can create. The power supply received by the base 4 allows the base to recharge and power the display module 3, the bank payment reading means 5 and the printer. The physical data connection including in the connecting means 31 can serve as either a primary connection to internet or as a back up to a wireless connection. The tether also acts as an additional security measure in combination with a retaining screw which fixes the base 4 to the counter.

The merchant can use the display module 3 to display a variety of product information and marketing material using suitable known software and in this way provide the customer with a more satisfying and informed retailing experience. Through the use of price or product comparison the merchant can also provide the customer with the best opportunity and a positive retail experience. The display is ideally a touch screen display with a digitising layer to permit easier interaction between the merchant or customer and the tablet computer 9.

Preferably the tablet computer 9 is also in wireless communication with a computer network to transfer and approve transaction details and update product information.

The information panels 20 correspond to the shape of their respective location on the retail transaction system 1 so as to cover the surface edge to edge. The information panels 20 affix using a suitable removable fitting so that alternative information panels 20 can be removed and replaced. The information panel 20 which affixes to the back of the display module will be dedicated to the model of the tablet computer 9, but it is possible for the base 4 to accommodate alternative models through the use of display module connecting means 8. Preferably the base station 4 provides a power connection for replenishing the battery of the display module 3 and data communication means for backup and update when wireless communication is not possible and when the display module 3 and bank payment reader means 5 are connected to the base 4. The tablet computer 9 connects to the bank payment reader means wirelessly. The base 4 then connects to a separate computer network (not shown) via an external USB connection means (not shown). The base 4 may be securely fastened to a fixed surface via retaining screws through dock-to-surface retaining screw holes (not shown); these are inaccessible whilst the base is engaged with the counter (not shown). Whilst the display module 3 is engaged with the base 4 it can still be used as a traditional fixed till and is preferably lockable and cannot be removed without merchant approval, using a key inserted into a key hole (not shown), for security purposes.

The display module 3 is removably attachable to the bank payment reading means 5 and the display module support 10 by means of display module connecting means 8 on the back of the display module 3. Both the bank card reading means 5 and the display module 3 can be used whether or not they are attached to each other or the base 4.

The retail transaction system 1 includes a fault management system, wherein a faulty component e.g. printer paper or module i.e. the bank payment reading means 5 the display module 3 or the printer, causing the retail transaction system to as a whole malfunction, can be identified and so it can be replaced. Replacement parts can be kept nearby so there is no time wasted on repairs or part delivery. The retail transaction system, being modular, then allows the merchant to replace, refill, recharge or repair the modules as advised, quickly and easily.

The fault management system uses a processor (not shown) located in the display module 3, which processes the data from the printer, bank payment reading means 5 and the display module 3 and displays this data on the display side 24 of the display module 3. In another embodiment the processor could be permanently or separately located in the base unit, which could also have a separate diagnostic display.

The casing 2 and information panels 20 are all made from a sufficiently robust material, preferably a polycarbonate to protect from accidental damage or tampering.

The bank payment reading means 5 is removably attached to the base 4 or, alternatively the display module 3. The display module 3 and the bank payment reading means 5 attach to the respective apparatus, 10 and 11, and together by means of a mutual sliding tongue and slot mechanism. The tongue 14, being a constituent of the display module support 10 and the bank card reading means 5 not only allows for easy removal but also permits flexibility in the type and size of the attached bank payment reading means 5. The bank card reading means 5 or the base 4 and the display module 3 attach together by means of the same mutual sliding tongue and slot mechanism. The slot, being a constituent of the display module connecting means 8 and the bank payment reader support 11, not only allows for easy removal but also permits flexibility in the type and size of the attached display module 3 and bank card reading means respectively so different models of bank card reading means and display module can be used. The display module 3 and the bank card reading means 5 are locked in place by the locking means (not shown), a constituent of the display module connecting means 8 and the bank payment reader support 11.

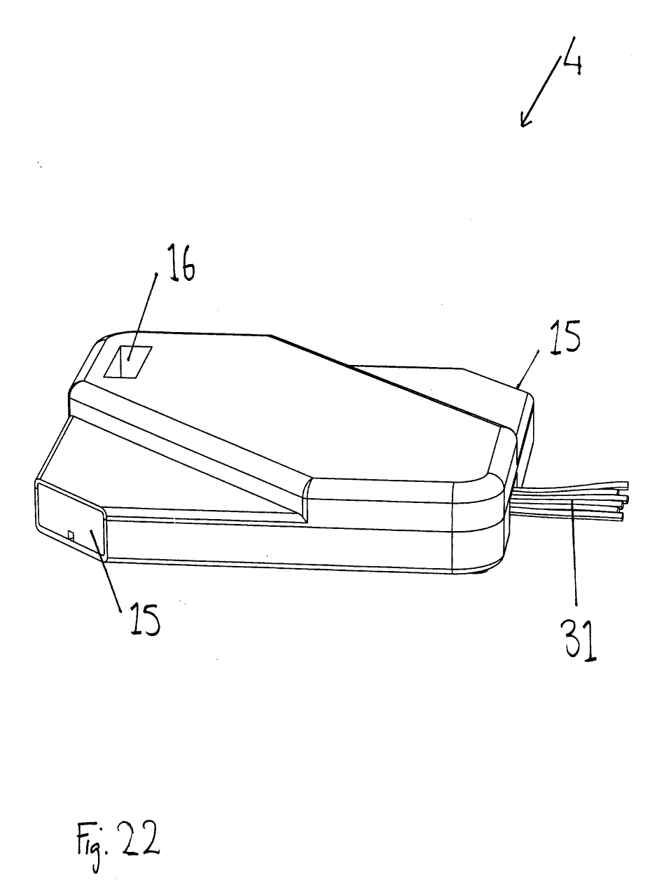

The bank payment reader support, the display module support and the printer housing are all replaceable and removable from the base. The display module support 10 and the bank payment reader support 11 attach to the base by the base-support attaching means 15. The printer attaches to the base via the printer housing 30 by the base-printer housing attaching means 16, as seen in FIG. 22.

It will be appreciated that the term tablet computer 9 can include any computing device which includes a display that is large enough to effectively display products or services in a retail environment and includes suitably adapted notebooks or laptops and the like.

1-52. (canceled)

53. A retail transaction system comprising: a display module, a display module support, a bank payment reader, a bank payment reader support, a printer module and a base arranged to be fixable to a payment counter, wherein at least one of, the display module, the bank payment reader and the printer module are removably attachable to the base and that the display module is in wireless communication with at least one of the bank payment reader and the printer module, and in that the display module is removably attachable to the display module support.

54. A retail transaction system according to claim 53, wherein the display module, bank payment reading means and printer are interconnected such that if there is a fault or a battery is low this is detectable and can be indicated via the display module.

55. A retail transaction system according to claim 53, wherein the display module is rotatably movable, between a first merchant facing position and a second customer facing position.

56. A retail transaction system according to claim 53, wherein the display module and the bank payment means include mutually cooperative attachment means to enable them to be fixable to each other.

57. A retail transaction system according to claim 53, wherein at least one of the display module support and the bank payment reader support are removable from the base, for locating in an alternative location, in which alternative location the display module or bank payment reader are still in wireless communication.

58. A retail transaction system according to claim 53, wherein the tablet computer is in wireless communication with an external computer network, which transfers the transaction details and also serves to update product information.

59. A retail transaction system according to claim 53, wherein the display module includes a display casing which is lockable via a latching means to the base for security to prevent unauthorised removal.

60. A retail transaction system according to claim 53, wherein the base includes automatic data connection means to enable data communication between the bank payment reading means, the display module and the printer when they are interconnected upon being attached to the base.

61. A retail transaction system according to claim 53, wherein the base is attached to the payment counter by a single lead which provides power, data connectivity and security from theft.

62. A retail transaction system according to claim 53, wherein the base is an inverted U shape with vertically extending sides each forming a respective top part with having an angled surface for receiving the display and the card reader respectively.

63. A retail transaction system according to claim 53, wherein a computer processor located in the base.

64. A retail transaction system according to claim 53, wherein when both the bank payment reader and the display module are removed from the base, the bank payment reader is removably attached to the display module by removable attachment means thus create a single portable point of sale transaction unit.

65. A retail transaction system according to claim 53, wherein the removable attachment means are provided in the form of corresponding sliding surfaces on the display module and on a housing of the bank payment reading means.

66. A retail transaction system according to claim 65, wherein the removable attachment means includes a spring loaded detent.

67. A retail transaction system comprising: a display module, a display module support, a bank payment reader, a bank payment reader support, a printer module and a base arranged to be fixed to a payment counter, wherein at least one of, the display module, the bank payment reader and the printer module are removably affixed to the base and that the display module is in wireless communication with at least one of the bank payment reader and the printer module and in that the system can be arranged in a first configuration in a first location in which the bank payment reader, the bank payment reader support, the display module, the display module support and the printer are affixed to the base and the system functions in this configuration, and the system can subsequently be arranged in an alternative second configuration, in a second location in which one of the bank payment reader, the bank payment reader support, the display module, the display module support and the printer is not connected to the base but is located in an alternative location.

68. A retail transaction system according to claim 67, including a customer side and a merchant side, and at least one panel for displaying information, wherein the at least one panel is removable and replaceable with an alternative panel appropriate for the alternative configuration.
